(19) United States
(12) Patent Application Publication
(10) Pub. No.: US 2026/0252054 A1
(43) Pub. Date: Aug. 27, 2026

(54) FIELD OPERATIONS FRAMEWORK

(71) Applicant: Schlumberger Technology Corporation, Sugar Land, TX (US)

(72) Inventors: Geir Kroslid, Kristiansand (NO); Anstein Jorud, Kristiansand (NO); Jason Enderby, Kristiansand (NO)

(21) Appl. No.: 19/063,903

(22) Filed: Feb. 26, 2025

(51) Int. Cl. G05B 19/4155

(52) U.S. Cl. CPC G05B 19/4155; G05B 2219/31229

(57) ABSTRACT

A method may include receiving, by an equipment-based interception layer, automation instructions from a computational framework for control of a field equipment system; receiving, by the equipment-based interception layer, human-initiated instructions from an electronic operator chair for performance of operations by the field equipment system; transmitting, by the equipment-based interception layer and responsive to receipt of one or more of the automation instructions and the human-initiated instructions, control instructions to control one or more subsystems of the field equipment system; receiving, by the equipment-based interception layer, feedback from one or more of the subsystems responsive to implementation of the control instructions; and transmitting the feedback to one or more of the computational framework and the electronic operator chair.

### BACKGROUND

A reservoir may be a subsurface formation that may be characterized at least in part by its porosity and fluid permeability. As an example, a reservoir may be part of a basin such as a sedimentary basin. A basin may be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

Drilling operations may be performed to construct a borehole according to a trajectory that penetrates a reservoir, etc., where fluid may be produced via the borehole, where fluid may be injected via the borehole, etc. As an example, one or more workflows may be performed using one or more computational frameworks, systems, etc., for one or more of analysis, acquisition, model building, control, etc., for exploration, interpretation, drilling, fracturing, production, etc.

### SUMMARY

A method may include receiving, by an equipment-based interception layer, automation instructions from a computational framework for control of a field equipment system; receiving, by the equipment-based interception layer, human-initiated instructions from an electronic operator chair for performance of operations by the field equipment system; transmitting, by the equipment-based interception layer and responsive to receipt of one or more of the automation instructions and the human-initiated instructions, control instructions to control one or more subsystems of the field equipment system; receiving, by the equipment-based interception layer, feedback from one or more of the subsystems responsive to implementation of the control instructions; and transmitting the feedback to one or more of the computational framework and the electronic operator chair. A system may include one or more processors; memory accessible to at least one of the one or more processors; and processor-executable instructions stored in the memory and executable to instruct the system to: receive automation instructions from a computational framework for control of a field equipment system; receive human-initiated instructions from an electronic operator chair for performance of operations by the field equipment system; transmit, responsive to receipt of one or more of the automation instructions and the human-initiated instructions, control instructions to control one or more subsystems of the field equipment system; receive feedback from one or more of the subsystems responsive to implementation of the control instructions; and transmit the feedback to one or more of the computational framework and the electronic operator chair. One or more computer-readable storage media may include processor-executable instructions to instruct a computing system to: receive automation instructions from a computational framework for control of a field equipment system; receive human-initiated instructions from an electronic operator chair for performance of operations by the field equipment system; transmit, responsive to receipt of one or more of the automation instructions and the human-initiated instructions, control instructions to control one or more subsystems of the field equipment system; receive feedback from one or more of the subsystems responsive to implementation of the control instructions; and transmit the feedback to one or more of the computational framework and the electronic operator chair. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The following detailed description refers to the accompanying drawings. Wherever convenient Features and advantages of the described implementations may be more readily understood by reference to the following description taken in conjunction with the accompanying drawings.

FIG. 1 shows an example of a system;

FIG. 2 shows an example of a system;

FIG. 3 shows an example of a system;

FIG. 4 shows an example of a system;

FIG. 5 shows an example of a system;

FIG. 6 shows an example of a system;

FIG. 7 shows an example of a system;

FIG. 8 shows an example of a workflow;

FIG. 9 shows an example of a workflow;

FIG. 10 shows an example of a system;

FIG. 11 shows an example of a graphic;

FIG. 12 shows an example of a method and an example of a system; and

FIG. 13 shows an example of a system.

### DETAILED DESCRIPTION

This description is not to be taken in a limiting sense, but rather is made merely for the purpose of describing the general principles of the implementations. The scope of the described implementations should be ascertained with reference to the issued claims.

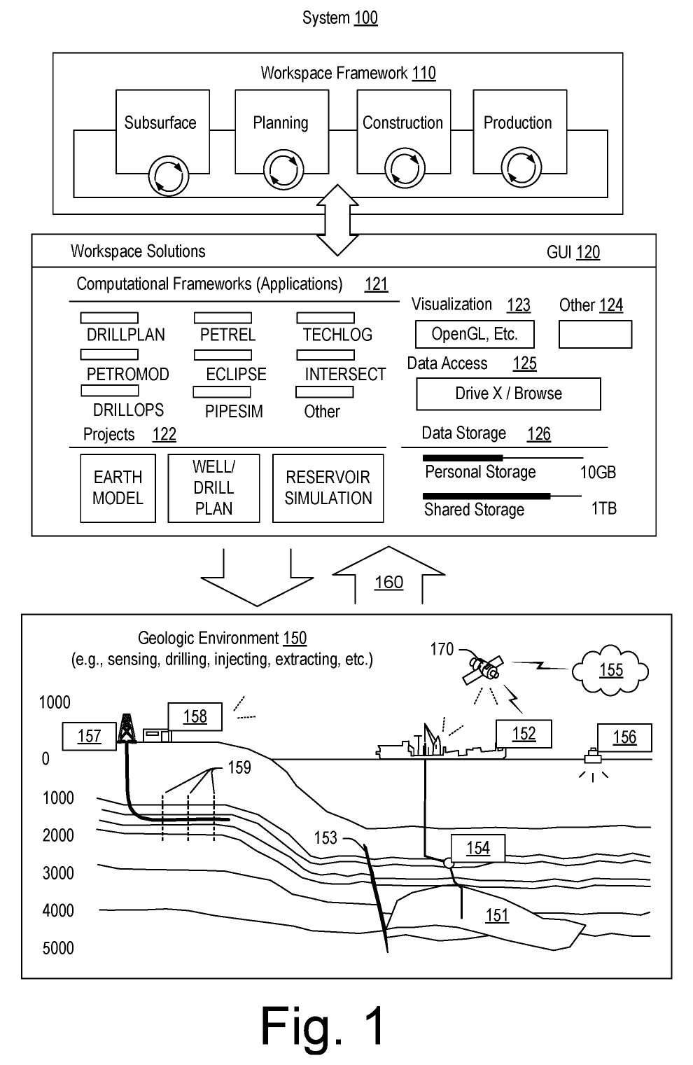

FIG. 1 shows an example of a system 100 that includes a workspace framework 110 that may provide for instantiation of, rendering of, interactions with, etc., a graphical user interface (GUI) 120. In the example of FIG. 1, the GUI 120 may include graphical controls for computational frameworks (e.g., applications, etc.) 121, projects 122, visualization features 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite 170 in communication with the network 155 that may be configured for communications, noting that the satellite 170 may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, DRILLOPS, PETREL, TECHLOG, PETROMOD, ECLIPSE, PIPESIM, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The DRILLOPS framework may execute a digital drilling plan and ensures plan adherence, while delivering goal-based automation. The DRILLOPS framework may generate activity plans automatically individual operations, whether they are monitored and/or controlled on the rig or in town. Automation may utilize data analysis and learning systems to assist and optimize tasks, such as, for example, setting ROP to drilling a stand. A preset menu of automatable drilling tasks may be rendered, and, using data analysis and models, a plan may be executed in a manner to achieve a specified goal, where, for example, measurements may be utilized for calibration. The DRILLOPS framework provides flexibility to modify and replan activities dynamically, for example, based on a live appraisal of various factors (e.g., equipment, personnel, and supplies). Well construction activities (e.g., tripping, drilling, cementing, etc.) may be continually monitored and dynamically updated using feedback from operational activities. The DRILLOPS framework may provide for various levels of automation based on planning and/or re-planning (e.g., via the DRILLPLAN framework), feedback, etc.

The PETREL framework may be part of the DELFI environment for utilization in geosciences and geoengineering, for example, to analyze subsurface data from exploration to production of fluid from a reservoir. The DELFI cognitive exploration and production (E&P) environment (SLB, Houston, Texas), referred to herein as the DELFI environment or DELFI framework, is a secure, cognitive, cloud-based collaborative environment that integrates data and workflows with digital technologies, such as artificial intelligence and machine learning.

The PETREL framework provides components that allow for optimization of various exploration, development and production operations. The PETREL framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes (e.g., with respect to one or more geologic environments, etc.). Such a framework may be considered an application (e.g., executable using one or more devices) and may be considered a data-driven application (e.g., where data is input for purposes of modeling, simulating, etc.).

The TECHLOG framework may handle and process field and laboratory data for a variety of geologic environments (e.g., deepwater exploration, shale, etc.). The TECHLOG framework may structure wellbore data for analyses, planning, etc.

The PETROMOD framework provides petroleum systems modeling capabilities that may combine one or more of seismic, well, and geological information to model the evolution of a sedimentary basin. The PETROMOD framework may predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework may produce reliable results, which may be continuously updated by real-time data exchanges (e.g., from one or more types of data acquisition equipment in the field that may acquire data during one or more types of field operations, etc.). The INTERSECT framework may provide completion configurations for complex wells where such configurations may be built in the field, may provide detailed enhanced-oil-recovery (EOR) formulations where such formulations may be implemented in the field, may analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases. For example, a workflow may utilize one or more of the DELFI environment on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 may be utilized for directing, controlling, etc., one or more processes in the geologic environment 150 and, feedback 160, may be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G frameworks (e.g., consider the PETREL framework, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process may implement one or more of various features that may be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. Such an approach may provide for compatibility of devices, frameworks, etc., with respect to one or more sets of instructions.

As an example, visualization features may provide for visualization of various earth models, properties, etc., in one or more dimensions. As an example, visualization features may provide for rendering of information in multiple dimensions, which may optionally include multiple resolution rendering. In such an example, information being rendered may be associated with one or more frameworks and/or one or more data stores. As an example, visualization features may include one or more control features for control of equipment, which may include, for example, field equipment that may perform one or more field operations. As an example, a workflow may utilize one or more frameworks to generate information that may be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results may be utilized to plan, simulate, perform, etc., one or more operations for production of fluid from a reservoir (e.g., reservoir rock, etc.).

As an example, a model may be a simulated version of a geologic environment. As an example, a simulator may include features for simulating physical phenomena in a geologic environment based at least in part on a model or models. A simulator, such as a reservoir simulator, may simulate fluid flow in a geologic environment based at least in part on a model that may be generated via a framework that receives seismic data. A simulator may be a computerized system (e.g., a computing system) that may execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that may be based on interpretation of seismic and/or other data. A spatial model may be a cell-based model where cells are defined by a grid (e.g., a mesh). A cell in a cell-based model may represent a physical area or volume in a geologic environment where the cell may be assigned physical properties (e.g., permeability, fluid properties, etc.) that may be germane to one or more physical phenomena (e.g., fluid volume, fluid flow, pressure, etc.). A reservoir simulation model may be a spatial model that may be cell-based.

While several simulators are illustrated in the example of FIG. 1, one or more other simulators may be utilized, additionally or alternatively. For example, consider the VISAGE geomechanics simulator (SLB, Houston Texas) or the PIPESIM network simulator (SLB, Houston Texas), etc.

As an example, a workflow may utilize one or more types of data for one or more processes (e.g., stratigraphic modeling, basin modeling, completion designs, drilling, production, injection, etc.). As an example, one or more tools may provide data that may be used in a workflow or workflows that may implement one or more frameworks (e.g., PETREL, TECHLOG, PETROMOD, ECLIPSE, etc.).

In the example of FIG. 1, drilling may be performed in the geologic environment 150, for example, to access the reservoir 151, which may be accessed from land or offshore. In FIG. 1, the downhole equipment 154 may be, for example, part of a bottom hole assembly (BHA). The BHA may be used to drill a well. The downhole equipment 154 may communicate information to equipment at the surface, and may receive instructions and information from the equipment at the surface. During a well construction process, a variety of operations (such as cementing, wireline evaluation, testing, etc.) may be conducted. In such embodiments, data collected by tools and sensors and used for reasons such as reservoir characterization may be collected and transmitted.

A well may include a substantially horizontal portion (e.g., lateral portion) that may intersect with one or more fractures. For example, a well in a shale formation may pass through natural fractures, artificial fractures (e.g., hydraulic fractures), or a combination thereof. Such a well may be constructed using directional drilling techniques as described herein. However, these same techniques may be used in connection with other types of directional wells (such as slant wells, S-shaped wells, deep inclined wells, and others) and are not limited to horizontal wells.

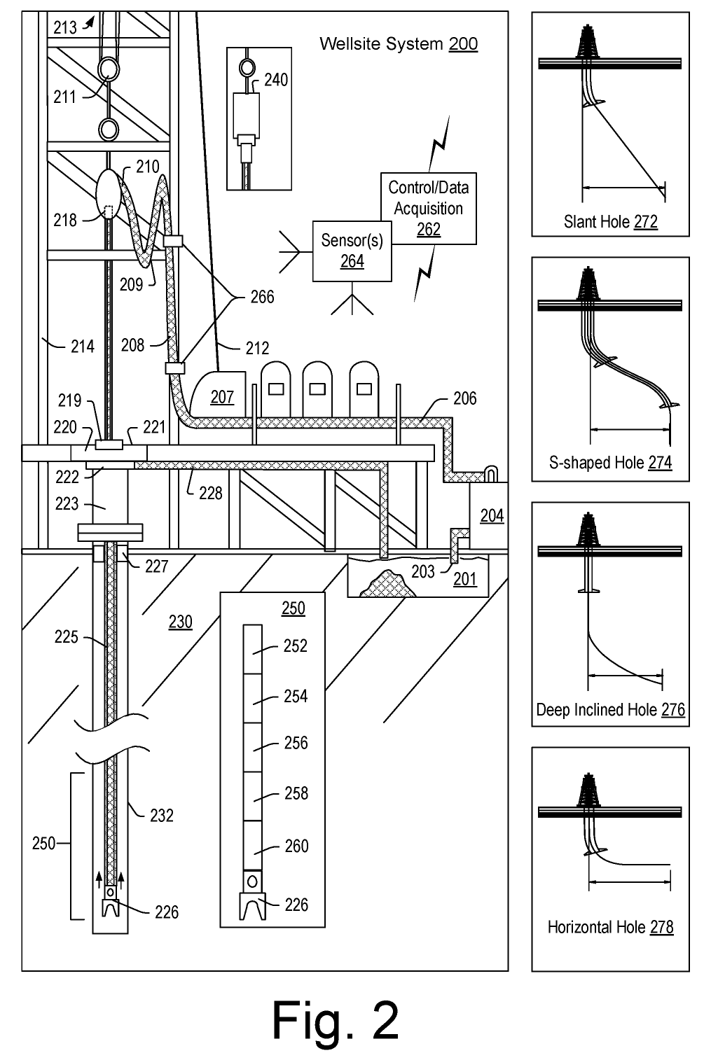

FIG. 2 shows an example of a wellsite system 200 (e.g., at a wellsite that may be onshore or offshore). As shown, the wellsite system 200 may include a mud tank 201 for holding mud and other material (e.g., where mud may be a drilling fluid), a suction line 203 that serves as an inlet to a mud pump 204 for pumping mud from the mud tank 201 such that mud flows to a vibrating hose 206, a drawworks 207 for winching drill line or drill lines 212, a standpipe 208 that receives mud from the vibrating hose 206, a kelly hose 209 that receives mud from the standpipe 208, a gooseneck or goosenecks 210, a traveling block 211, a crown block 213 for carrying the traveling block 211 via the drill line or drill lines 212, a derrick 214, a kelly 218 or a top drive 240, a kelly drive bushing 219, a rotary table 220, a drill floor 221, a bell nipple 222, one or more blowout preventors (BOPs) 223, a drillstring 225, a drill bit 226, a casing head 227 and a flow pipe 228 that carries mud and other material to, for example, the mud tank 201.

In the example system of FIG. 2, a borehole 232 is formed in subsurface formations 230 by rotary drilling; noting that various example embodiments may also use one or more directional drilling techniques, equipment, etc.

As shown in the example of FIG. 2, the drillstring 225 is suspended within the borehole 232 and has a drillstring assembly 250 that includes the drill bit 226 at its lower end. As an example, the drillstring assembly 250 may be a bottom hole assembly (BHA).

The wellsite system 200 may provide for operation of the drillstring 225 and other operations. As shown, the wellsite system 200 includes the traveling block 211 and the derrick 214 positioned over the borehole 232. As mentioned, the wellsite system 200 may include the rotary table 220 where the drillstring 225 pass through an opening in the rotary table 220.

As shown in the example of FIG. 2, the wellsite system 200 may include the kelly 218 and associated components, etc., or a top drive 240 and associated components. As to a kelly example, the kelly 218 may be a square or hexagonal metal/alloy bar with a hole drilled therein that serves as a mud flow path. The kelly 218 may be used to transmit rotary motion from the rotary table 220 via the kelly drive bushing 219 to the drillstring 225, while allowing the drillstring 225 to be lowered or raised during rotation. The kelly 218 may pass through the kelly drive bushing 219, which may be driven by the rotary table 220. As an example, the rotary table 220 may include a master bushing that operatively couples to the kelly drive bushing 219 such that rotation of the rotary table 220 may turn the kelly drive bushing 219 and hence the kelly 218. The kelly drive bushing 219 may include an inside profile matching an outside profile (e.g., square, hexagonal, etc.) of the kelly 218; however, with slightly larger dimensions so that the kelly 218 may freely move up and down inside the kelly drive bushing 219.

As to a top drive example, the top drive 240 may provide functions performed by a kelly and a rotary table. The top drive 240 may turn the drillstring 225. As an example, the top drive 240 may include one or more motors (e.g., electric and/or hydraulic) connected with appropriate gearing to a short section of pipe called a quill, that in turn may be screwed into a saver sub or the drillstring 225 itself. The top drive 240 may be suspended from the traveling block 211, so the rotary mechanism is free to travel up and down the derrick 214. As an example, a top drive 240 may allow for drilling to be performed with more joint stands than a kelly/rotary table approach.

In the example of FIG. 2, the mud tank 201 may hold mud, which may be one or more types of drilling fluids. As an example, a wellbore may be drilled to produce fluid, inject fluid or both (e.g., hydrocarbons, minerals, water, etc.).

In the example of FIG. 2, the drillstring 225 (e.g., including one or more downhole tools) may be composed of a series of pipes threadably connected together to form a long tube with the drill bit 226 at the lower end thereof. As the drillstring 225 is advanced into a wellbore for drilling, at some point in time prior to or coincident with drilling, the mud may be pumped by the pump 204 from the mud tank 201 (e.g., or other source) via the lines 206, 208 and 209 to a port of the kelly 218 or, for example, to a port of the top drive 240. The mud may then flow via a passage (e.g., or passages) in the drillstring 225 and out of ports located on the drill bit 226 (see, e.g., a directional arrow). As the mud exits the drillstring 225 via ports in the drill bit 226, it may then circulate upwardly through an annular region between an outer surface(s) of the drillstring 225 and surrounding wall(s) (e.g., open borehole, casing, etc.), as indicated by directional arrows. In such a manner, the mud lubricates the drill bit 226 and carries heat energy (e.g., frictional or other energy) and formation cuttings to the surface where the mud (e.g., and cuttings) may be returned to the mud tank 201, for example, for recirculation (e.g., with processing to remove cuttings, etc.).

The mud pumped by the pump 204 into the drillstring 225 may, after exiting the drillstring 225, form a mudcake that lines the wellbore which, among other functions, may reduce friction between the drillstring 225 and surrounding wall(s) (e.g., borehole, casing, etc.). A reduction in friction may facilitate advancing or retracting the drillstring 225. During a drilling operation, the entire drillstring 225 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 226 of the drillstring 225 at a bottom of a wellbore, pumping of the mud commences to lubricate the drill bit 226 for purposes of drilling to enlarge the wellbore. As mentioned, the mud may be pumped by the pump 204 into a passage of the drillstring 225 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may modulated. In such an example, information from downhole equipment (e.g., one or more modules of the drillstring 225) may be transmitted uphole to an uphole device, which may relay such information to other equipment for processing, control, etc.

As an example, telemetry equipment may operate via transmission of energy via the drillstring 225 itself. For example, consider a signal generator that imparts coded energy signals to the drillstring 225 and repeaters that may receive such energy and repeat it to further transmit the coded energy signals (e.g., information, etc.).

As an example, the drillstring 225 may be fitted with telemetry equipment 252 that includes a rotatable drive shaft, a turbine impeller mechanically coupled to the drive shaft such that the mud may cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such an example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 2, an uphole control and/or data acquisition system 262 may include circuitry to sense pressure pulses generated by telemetry equipment 252 and, for example, communicate sensed pressure pulses or information derived therefrom for process, control, etc.

The assembly 250 of the illustrated example includes a logging-while-drilling (LWD) module 254, a measurement-while-drilling (MWD) module 256, an optional module 258, a rotary-steerable system (RSS) and/or motor 260, and the drill bit 226. Such components or modules may be referred to as tools where a drillstring may include a plurality of tools.

As to an RSS, it involves technology utilized for directional drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling may commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

One approach to directional drilling involves a mud motor; however, a mud motor may present some challenges depending on factors such as rate of penetration (ROP), transferring weight to a bit (e.g., weight on bit, WOB) due to friction, etc. A mud motor may be a positive displacement motor (PDM) that operates to drive a bit (e.g., during directional drilling, etc.). A PDM operates as drilling fluid is pumped through it where the PDM converts hydraulic power of the drilling fluid into mechanical power to cause the bit to rotate.

As an example, a mud motor (e.g., PDM) may be operated in different modes, which may include a rotating mode and a sliding mode. A sliding mode involves drilling with a mud motor rotating the bit downhole without rotating the drillstring from the surface; noting that the drillstring may be oscillated from the surface clockwise and counter-clockwise to reduce friction, etc. Such an operation may be conducted when a BHA has been fitted with a bent sub or a bent housing mud motor, or both, for directional drilling. Sliding may be used in building and controlling or adjusting hole angle. In directional drilling, pointing of a bit may be accomplished through a bent sub, which may have a relatively small angle offset from the axis of a drillstring, and a measurement device to determine the direction of offset. Without turning the drillstring as in rotary drilling (e.g., a rotating mode), the bit may be rotated with mud flow through the mud motor to drill in the direction it is pointed. With steerable motors, when a desired wellbore direction is attained, the entire drillstring may be rotated to drill straight rather than at an angle. By controlling the amount of hole drilled in the sliding mode versus the rotating mode, a wellbore trajectory may be controlled rather precisely.

As an example, a PDM may operate in a combined rotating mode where surface equipment is utilized to rotate a bit of a drillstring (e.g., a rotary table, a top drive, etc.) by rotating the entire drillstring and where drilling fluid is utilized to rotate the bit of the drillstring. In such an example, a surface RPM (SRPM) may be determined by use of the surface equipment and a downhole RPM of the mud motor may be determined using various factors related to flow of drilling fluid, mud motor type, etc. As an example, in the combined rotating mode, bit RPM may be determined or estimated as a sum of the SRPM and the mud motor RPM, assuming the SRPM and the mud motor RPM are in the same direction.

As an example, a PDM mud motor may operate in a so-called sliding mode, when the drillstring is not rotated from the surface. In such an example, a bit RPM may be determined or estimated based on the RPM of the mud motor.

An RSS may drill directionally where there is continuous rotation from surface equipment, which may alleviate the sliding of a steerable motor (e.g., a PDM). An RSS may be deployed when drilling directionally (e.g., deviated, horizontal, or extended-reach wells). An RSS may aim to minimize interaction with a borehole wall, which may help to preserve borehole quality. An RSS may aim to exert a relatively consistent side force akin to stabilizers that rotate with the drillstring or orient the bit in the desired direction while continuously rotating at the same number of rotations per minute as the drillstring.

The LWD module 254 may be housed in a suitable type of drill collar and may contain one or a plurality of selected types of logging tools. It will also be understood that more than one LWD and/or MWD module may be employed. Where the position of an LWD module is mentioned, as an example, it may refer to a module at the position of the LWD module 254, the MWD module 256, etc. An LWD module may include capabilities for measuring, processing, and storing information, as well as for communicating with the surface equipment. In the illustrated example, the LWD module 254 may include a seismic measuring device.

The MWD module 256 may be housed in a suitable type of drill collar and may contain one or more devices for measuring characteristics of the drillstring 225 and the drill bit 226. As an example, the MWD module 256 may include equipment for generating electrical power, for example, to power various components of the drillstring 225. As an example, the MWD module 256 may include the telemetry equipment 252, for example, where the turbine impeller may generate power by flow of the mud; it being understood that other power and/or battery systems may be employed for purposes of powering various components. As an example, the MWD module 256 may include one or more of the following types of measuring devices: a weight-on-bit measuring device, a torque measuring device, a vibration measuring device, a shock measuring device, a stick slip measuring device, a direction measuring device, and an inclination measuring device.

FIG. 2 also shows some examples of types of holes that may be drilled. For example, consider a slant hole 272, an S-shaped hole 274, a deep inclined hole 276 and a horizontal hole 278.

As an example, a drilling operation may include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees.

As an example, a directional well may include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of a downhole motor and/or a turbine. As to a motor, for example, a drillstring may include a positive displacement motor (PDM).

As an example, a system may be a steerable system and include equipment to perform method such as geosteering. As mentioned, a steerable system may be or include an RSS. As an example, a steerable system may include a PDM or of a turbine on a lower part of a drillstring which, just above a drill bit, a bent sub may be mounted. As an example, above a PDM, MWD equipment that provides real time or near real time data of interest (e.g., inclination, direction, pressure, temperature, real weight on the drill bit, torque stress, etc.) and/or LWD equipment may be installed. As to the latter, LWD equipment may make it possible to send to the surface various types of data of interest, including for example, geological data (e.g., gamma ray log, resistivity, density and sonic logs, etc.).

As an example, geosteering may be employed (e.g., control of directional drilling using geological data). The coupling of sensors providing information on the course of a well trajectory, in real time or near real time, with, for example, one or more logs characterizing the formations from a geological viewpoint, may allow for implementing a geosteering method. Such a method may include navigating a subsurface environment, for example, to follow a desired route to reach a desired target or targets.

As an example, a drillstring may include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

As an example, geosteering may include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 2, the wellsite system 200 may include one or more sensors 264 that are operatively coupled to the control and/or data acquisition system 262. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 200. As an example, a sensor or sensor may be at an offset wellsite where the wellsite system 200 and the offset wellsite are in a common field (e.g., oil and/or gas field).

As an example, one or more of the sensors 264 may be provided for tracking pipe, tracking movement of at least a portion of a drillstring, etc.

As an example, the system 200 may include one or more sensors 266 that may sense and/or transmit signals to a fluid conduit such as a drilling fluid conduit (e.g., a drilling mud conduit). For example, in the system 200, the one or more sensors 266 may be operatively coupled to portions of the standpipe 208 through which mud flows. As an example, a downhole tool may generate pulses that may travel through the mud and be sensed by one or more of the one or more sensors 266. In such an example, the downhole tool may include associated circuitry such as, for example, encoding circuitry that may encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 200 may include a transmitter that may generate signals that may be transmitted downhole via mud (e.g., drilling fluid) as a transmission medium.

As an example, one or more portions of a drillstring may become stuck. The term stuck may refer to one or more of varying degrees of inability to move or remove a drillstring from a bore. As an example, in a stuck condition, it might be possible to rotate pipe or lower it back into a bore or, for example, in a stuck condition, there may be an inability to move the drillstring axially in the bore, though some amount of rotation may be possible. As an example, in a stuck condition, there may be an inability to move at least a portion of the drillstring axially and rotationally.

As to the term “stuck pipe”, this may refer to a portion of a drillstring that cannot be rotated or moved axially. As an example, a condition referred to as “differential sticking” may be a condition whereby the drillstring cannot be moved (e.g., rotated or reciprocated) along the axis of the bore. Differential sticking may occur when high-contact forces caused by low reservoir pressures, high wellbore pressures, or both, are exerted over a sufficiently large area of the drillstring. Differential sticking may have time and financial cost.

As an example, a sticking force may be a product of the differential pressure between the wellbore and the reservoir and the area that the differential pressure is acting upon. This means that a relatively low differential pressure (delta p) applied over a large working area may be just as effective in sticking pipe as may a high differential pressure applied over a small area.

As an example, a condition referred to as “mechanical sticking” may be a condition where limiting or prevention of motion of the drillstring by a mechanism other than differential pressure sticking occurs. Mechanical sticking may be caused, for example, by one or more of junk in the hole, wellbore geometry anomalies, cement, keyseats or a buildup of cuttings in the annulus.

As explained, a wellsite system may include various types of equipment for handling fluid such as, for example, drilling fluid (e.g., mud). As explained, drilling fluid may provide one or more functions (e.g., lubrication, transport of cutting, etc.).

Drilling fluid may be composed of a number of liquid and/or gaseous fluids and mixtures of fluids and solids (e.g., as solid suspensions, mixtures and emulsions of liquids, gases and solids) as may be used in various operations to drill boreholes into the earth. Classifications of drilling fluids may utilize one or more types of classification schemes. For example, consider water-based mud (WBM), oil-based mud (OBM), nonaqueous-based mud (NQBM), gaseous-based mud (e.g., pneumatic, etc.) (GBM), etc.

As explained, a drillstring may include a mud motor that is rotationally driven by flow of drilling fluid. In such a mode of drilling, the characteristics of drilling fluid may impact mud motor performance. For example, density (e.g., mud weight) may impact how much energy the mud motor may deliver to a drill bit for a given drilling fluid flow rate.

As to a stuck pipe or risk of sticking event, as explained, one or more actions may be taken. For example, consider addition of acid as a remedial action to address the stuck pipe event or to reduce the risk of a sticking event. In such an example, a number of barrels of acid may be added to drilling fluid that is circulated downhole to an annular region between a drilling string and a bore wall in an effort to “dissolve” material that is causing sticking or a risk of sticking. While addition of acid is mentioned, it may be an action within a tiered series of actions that may be taken, where, for example, each action may have associated benefits and detriments. As to detriments, these may include non-productive time (NPT), cost, further remedial actions (e.g., impact of acid on one or more additives in drilling fluid), etc. Hence, where an event occurs or a risk of an event is heightened, in an effort to maintain adherence to a plan, one or more actions may be implemented in a strategic manner to resolve the event or otherwise reduce the risk.

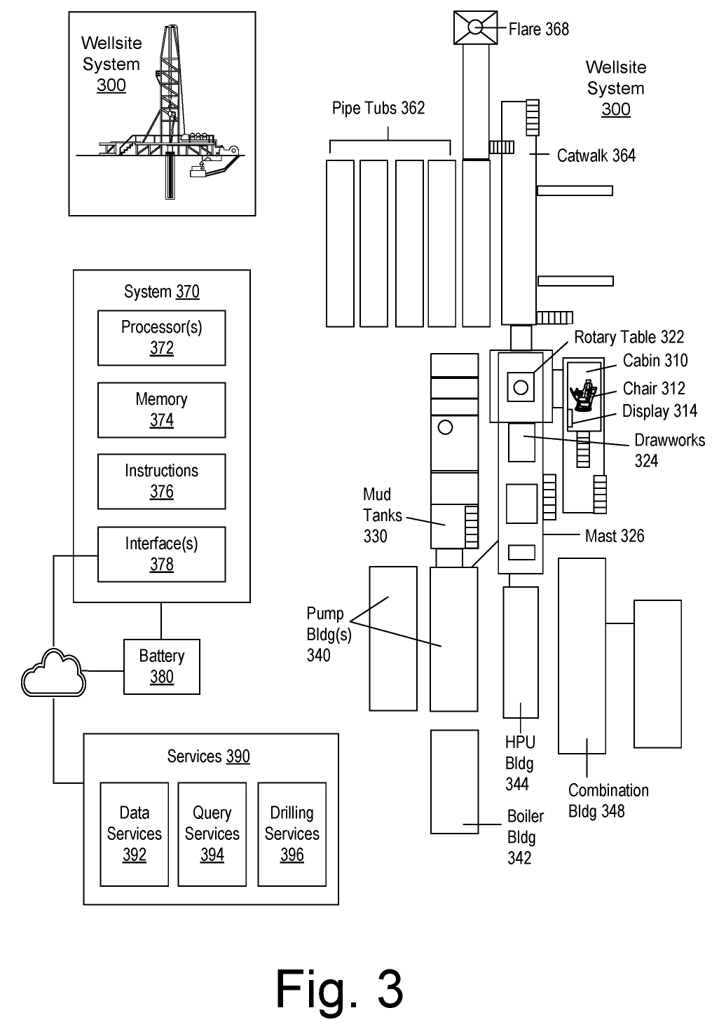

FIG. 3 shows an example of a wellsite system 300, specifically, FIG. 3 shows the wellsite system 300 in an approximate side view and an approximate plan view along with a block diagram of a system 370.

In the example of FIG. 3, the wellsite system 300 may include a cabin 310, a rotary table 322, drawworks 324, a mast 326 (e.g., optionally carrying a top drive, etc.), mud tanks 330 (e.g., with one or more pumps, one or more shakers, etc.), one or more pump buildings 340, a boiler building 342, an HPU building 344 (e.g., with a rig fuel tank, etc.), a combination building 348 (e.g., with one or more generators, etc.), pipe tubs 362, a catwalk 364, a flare 368, etc. Such equipment may include one or more associated functions and/or one or more associated operational risks, which may be risks as to time, resources, and/or humans.

As shown in the example of FIG. 3, the cabin 310 may be positioned near the rig, for example, near the rig floor such that a line-of-sight view may be established between the cabin 310 and the rig floor (e.g., via an opening, a window, etc.). As shown, the cabin 310 may house equipment such as, for example, a chair 312 and a display 314. In such an example, the chair 312 may be an operator chair. As an example, the cabin 310 may include one or more doors for access thereto. As an example, the chair 312 may include a swivel base such that an operator may rotate, tilt, etc., the chair 312. A U.S. Patent Publication having Publication No. 2021/0115776 A1, as published on April 22, 2021 (‘776 application), is incorporated by reference herein in its entirety and shows and describes various types of equipment that may be at a field site, include a cabin, one or more chairs, etc. As an example, an operator chair may include one or more of the features described in the ‘776 application.

As shown in the example of FIG. 3, the wellsite system 300 may include a system 370 that includes one or more processors 372, memory 374 operatively coupled to at least one of the one or more processors 372, instructions 376 that may be, for example, stored in the memory 374, and one or more interfaces 378. As an example, the system 370 may include one or more processor-readable media that include processor-executable instructions executable by at least one of the one or more processors 372 to cause the system 370 to control one or more aspects of the wellsite system 300. In such an example, the memory 374 may be or include the one or more processor-readable media where the processor-executable instructions may be or include instructions. As an example, a processor-readable medium may be a computer-readable storage medium that is not a signal and that is not a carrier wave.

FIG. 3 also shows a battery 380 that may be operatively coupled to the system 370, for example, to power the system 370. As an example, the battery 380 may be a back-up battery that operates when another power supply is unavailable for powering the system 370. As an example, the battery 380 may be operatively coupled to a network, which may be a cloud network. As an example, the battery 380 may include smart battery circuitry and may be operatively coupled to one or more pieces of equipment via a SMBus or other type of bus.

In the example of FIG. 3, services 390 are shown as being available, for example, via a cloud platform. Such services may include data services 392, query services 394 and drilling services 396. As an example, the services 390 may be part of a system such as the system 100 of FIG. 1 (e.g., consider planning services and/or operational services). As an example, the services 390 may include one or more services for directional drilling (e.g., consider a computational framework that may provide for one or more services that utilize real-time data to estimate one or more parameters, etc.).

As an example, the system 370 may be utilized to generate one or more rate of penetration drilling parameter values, which may, for example, be utilized to control one or more drilling operations.

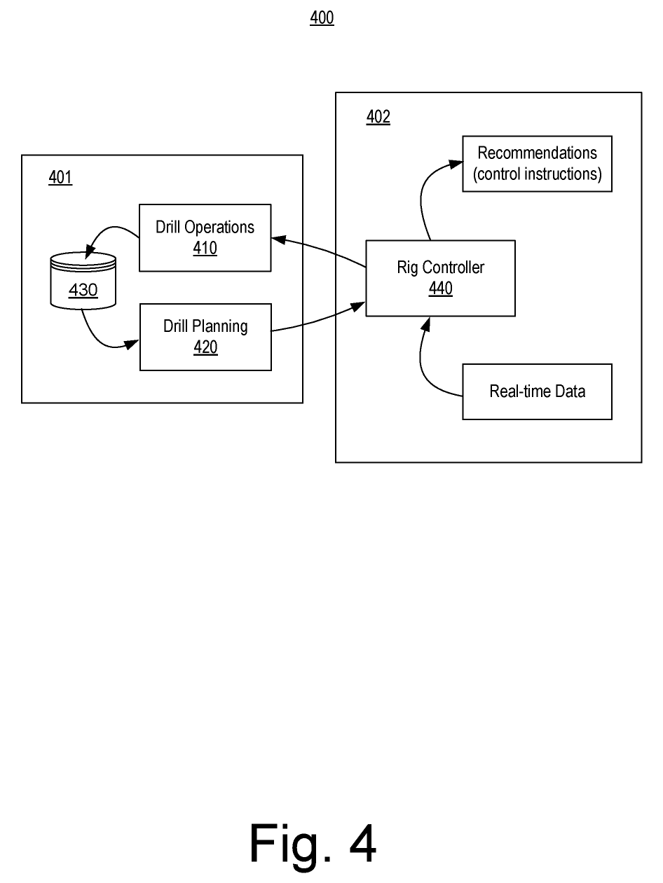

FIG. 4 shows an example of a system 400 that includes offsite equipment 401 (e.g., remote) and onsite equipment 402 (e.g., local). As shown, the offsite equipment 401 may include a drill operations framework 410, a drill planning framework 420 and a database 430 and the onsite equipment 402 may include a controller 440 that may receive real-time data and output recommendations such as control instructions to control onsite equipment. In such an example, the drill operations framework 410 may provide for steering sheets, execution parameters, etc., and the drill planning framework 420 may provide for evaluation of steering responses and statistics. As shown, the controller 440 may output information to the drill operations framework 410 and receive information from the drill planning framework 420. The system 400 may include plan generation features for real-time plan generation during drilling operations execution phase and/or plan generation during a planning phase. The system 400 may be utilized for one or more types of drilling (e.g., rotary, mud motor, RSS, ABSS, etc.). The system 400 may operate loops, which may include at least one real-time loop that provides for control of equipment to perform drilling operations.

A system such as the system 400 may utilize various functions and constraints for generation of plans, which may provide for single or multiple target aiming. As explained, a plan may be generated that aims to provide for drilling operations for a multiwell structure. As explained, a plan may be a digital plan that may be utilized to instruct one or more controllers such as, for example, an autodriller controller, which may control one or more pieces of equipment (e.g., a drawworks, a top drive, one or more drilling fluid pumps, etc.). As an example, an autodriller may control energy delivered via one or more pieces of equipment to a drill bit where the drill bit crushes and/or cuts rock to extend a borehole. As an example, an autodriller may be controlled in an effort that aims to minimize or otherwise reduce mechanical specific energy (MSE) and to maximize or otherwise increase rate of penetration (ROP).

As explained with respect to the system 100 of FIG. 1, various computational frameworks may be utilized to perform one or more workflows, which may include planning workflows, workflows involving control of field operations, workflows in real-time or near real-time, assessment workflows (e.g., for issues, successes, etc.), etc. As explained, one or more visualization features may be provided and utilized, for example, to implement visualization processes that may be suitable for one or more web applications. As mentioned, JSON and/or one or more other languages and/or formats may be utilized.

As an example, a framework may provide for generation of performance indicators for equipment. In such an example, the framework may include various automated procedures that may, for example, respond to one or more triggers to generate performance indicators for equipment. As an example, one or more performance indicators may be utilized by one or more other frameworks. For example, consider a workflow where automated generation of one or more performance indicators may cause one or more actions by one or more other frameworks, which may provide for tasks such as, for example, planning, optimization, control of field operations, etc.

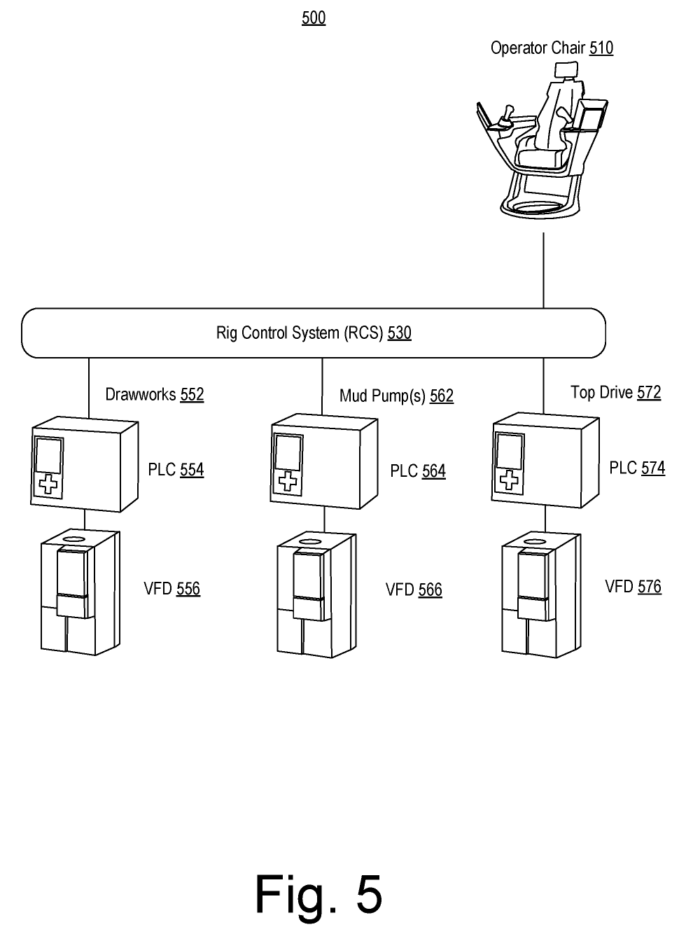

FIG. 5 shows an example of a system 500 that includes an operator chair 510 and a rig control system (RCS) 530 for control of one or more subsystems, which may include a drawworks subsystem 552, a mud pump(s) subsystem 562, and a top drive subsystem 572. In the example of FIG. 5, each of the subsystems 552, 562, and 572 may include a programmable logic controller (PLC) 554, 564, and 574, respectively, which may be operatively coupled to equipment such as, for example, a variable frequency drive (VFD) 556, 566, and 576, respectively. In the example of FIG. 5, an operator may provide for issuance of one or more commands via the operator chair 510 to cause the RCS 530 to control one or more of the subsystems 552, 562, and 572. For example, consider a command for controlling speed of an electric motor via one of the VFDs 556, 566, and 576, which, in turn, may cause a drawworks to take in or let out cable, a mud pump to increase or decrease pump rate, or a top drive to increase or decrease rotation of drill pipe.

In the example of FIG. 5, a command initiated by the operator chair may be interpreted, transformed, etc., by the RCS 530 and/or one or more components of a subsystem. In such an approach, the system 500 provides for human control of one or more of the subsystems 552, 562, and 572.

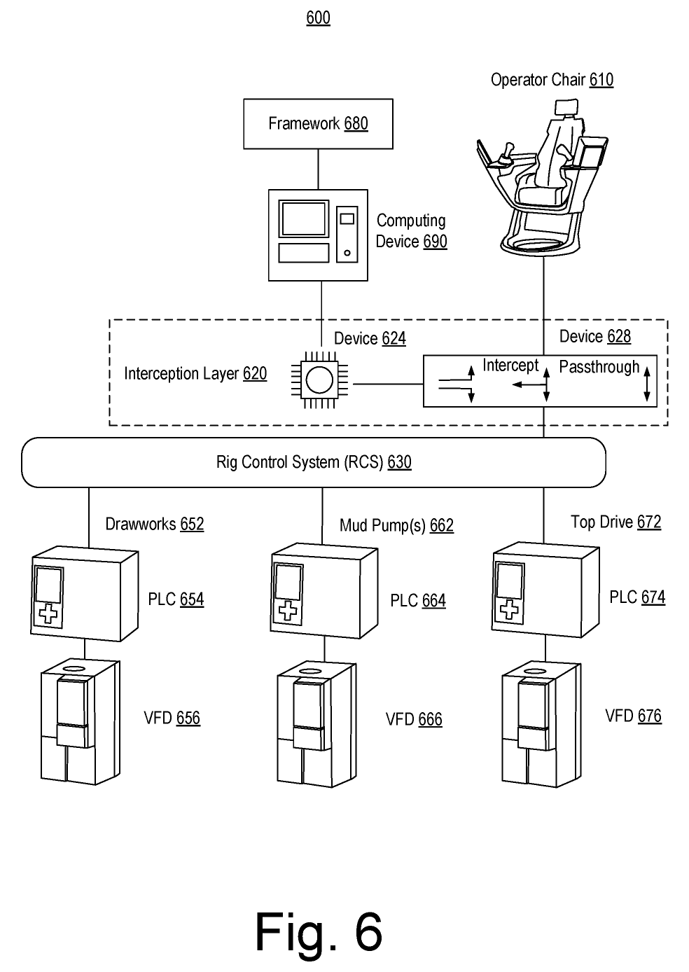

FIG. 6 shows an example of a system 600 that includes an operator chair 610, an interception layer 620, and a rig control system (RCS) 630 for control of one or more subsystems, which may include a drawworks subsystem 652, a mud pump(s) subsystem 662, and a top drive subsystem 672. In the example of FIG. 6, each of the subsystems 652, 662, and 672 may include a programmable logic controller (PLC) 654, 664, and 674, respectively, which may be operatively coupled to equipment such as, for example, a variable frequency drive (VFD) 656, 666, and 676, respectively.

In the example of FIG. 6, the system 600 also includes a framework 680 and a computing device 690, which may provide for execution of the framework 680 (e.g., as a computational framework). As to the interception layer 620, it may include one or more types of equipment, which may include computing equipment, networking equipment, etc. For example, consider a computing device 624 operatively coupled to a network device 628. In such an example, the framework 680 executable using the computing device 690 (e.g., local, remote, local and remote, etc.) may provide for transmission of instructions to the computing device 624 of the interception layer 620. In such an example, the computing device 624 may provide for structuring such instructions in a manner suitable for implementation by the RCS 630 where the network device 628 may provide for mediating instructions originating with execution of the framework 680 and instructions originating with interactions with the operator chair 610. In such an example, the RCS 630 may be suitably instructed via multiple sources, which may include the framework 680 as one source and the operator chair 610 as another, different source.

In various instances, one or more subsystems may be amenable to one or more levels of automated control. For example, consider levels from 0 to 5 where level 0 is manual control and where level 5 is autonomous control. In such an example, manual control at level 0 may be control via the operator chair 610 alone while automated control at level 5 may be control via the framework 680 alone, with possible monitoring via the operator chair 610 (e.g., for override, safety, etc.). As to the network device 628, it may provide for transmissions from the operator chair 610 and/or the framework 680 (e.g., as executing on the computing device 690) to the RCS 630. As an example, the network device 628 may provide for transmissions between various elements in the system 600, which may include the operator chair 610, the framework 680, the computing device 690, the computing device 624, the RCS 630, etc.

As an example, the mud pump(s) subsystem 662 may be controlled via transmissions originated at the operator chair 610 and/or the framework 680. As an example, such control may be responsive to one or more actions of the drawworks subsystem 652 and/or the top drive subsystem 672. For example, consider tuning autodriller parameters and downlinks. In such an example, an autodriller may provide for control of one or more of the drawworks subsystem 652, the mud pump(s) subsystem 662, and the top drive subsystem 672. In such an example, parameters may include one or more of set points and tuning parameters. For example, consider an autodriller that may operate as or be operatively coupled to proportional, integral, and/or derivative control circuitry (e.g., P, I, and/or D circuitry, etc.) where set points and tuning parameters may be utilized and dynamically updated as appropriate. As to downlinks, these may be types of transmissions with data and/or command payloads that are sent from a surface location using surface equipment to a downhole location. As an example, downlinks may include commands that instruct one or more pieces of downhole equipment to perform one or more actions. For example, consider a rotary steerable system (RSS) that may be directed to adjust a direction of a drill bit such that a borehole is steered with respect to one or more subsurface geologic structures (e.g., reservoir layers, etc.).

As another example, consider making a pipe connection for adding a length of pipe to a drillstring where a drawworks may provide for translating the length of pipe and where a top drive may provide for rotating the length of pipe to make the connection (e.g., consider a threaded connection made by rotating pipe). In such an example, after the connection is made, drilling may resume or other running pipe in hole (e.g., run in hole (RIH)), which may be accompanied by controlling the flow of mud via the mud pump(s) subsystem 662. In such an example, signals may be transmitted within the system 600 to cause the mud pump(s) subsystem 662 to be appropriately controlled, for example, at one or more levels of automation, which may or may not involve some extent of control via an operator interacting with the operator chair (e.g., a human-in-the-loop (HITL)). As explained, a framework such as the framework 680 may provide for some extent of automation, which may be responsive to occurrence of one or more events, actions, etc., as may be indicated via sensor data, equipment states, PLC states, VFD states, etc.

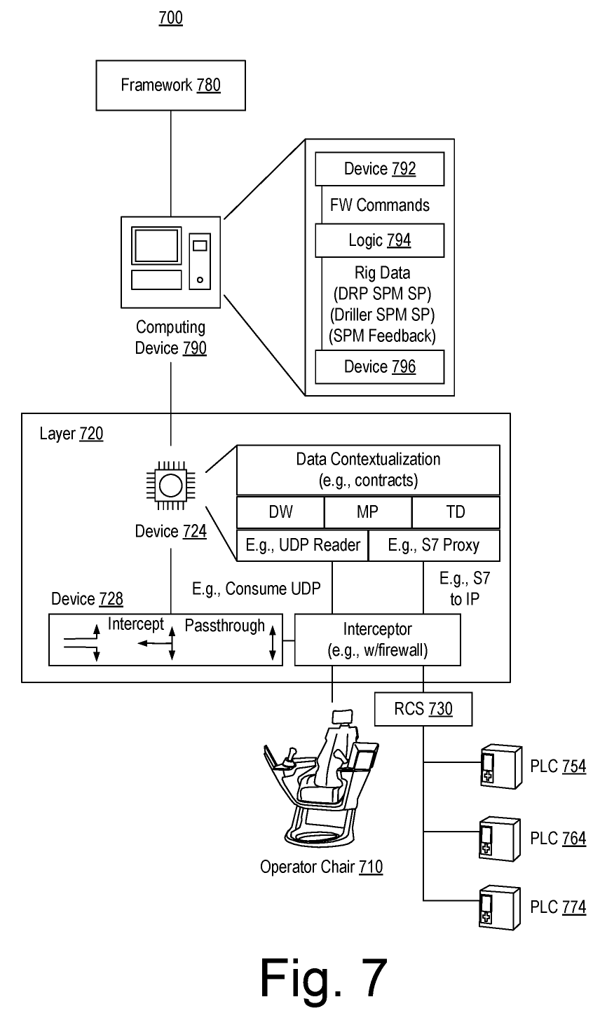

FIG. 7 shows an example system 700 that includes an operator chair 710, an interception layer 720, and a rig control system (RCS) 730 for control of one or more subsystems, which may include a drawworks subsystem, a mud pump(s) subsystem, and a top drive subsystem (see, e.g., the subsystems 652, 662, and 672 of FIG. 6). In the example of FIG. 7, each of the subsystems may include a programmable logic controller (PLC) 754, 764, and 774, respectively, which may be operatively coupled to equipment such as, for example, one or more VFDs.

In the example of FIG. 7, the system 700 also includes a framework 780 and a computing device 790, which may provide for execution of the framework 780 (e.g., as a computational framework). As to the interception layer 720, it may include one or more types of equipment, which may include computing equipment, networking equipment, etc. For example, consider a computing device 724 operatively coupled to a network device 728.

As shown, the computing device 790 may include a device 792 (e.g., client, server, etc.) for framework (FW) commands to logic 794 that can generate rig data, set-points, feedback, etc., which may be provided to another device 796 (e.g., client, server, etc.). In such an example, where one or both of the devices 792 and 796 is a server, a server may be a hardware server or a virtual machine server (e.g., a virtual instance of a server executable via instructions by one or more processors, etc.). As to the computing device 724, it may provide for data contextualization for equipment subsystems (e.g., drawworks (DW), mud pump(s) (MP), top drive (TD), etc.). The computing device 724 may also provide for user datagram protocol (UDP) and S7 operations.

As to S7, it is a protocol that may be utilized in an Ethernet implementation where it may rely on ISO TCP (RFC1006) which, by design, is block oriented. In such an example, each block may be named a Protocol Data Unit (PDU), with its maximum length depending on a communication unit (CP), as may be negotiated during a connection. A CP may be a specialized processor that may use the S7 protocol without TCP/IP layers. The S7 protocol may be utilized for various tasks, which may include, for example, one or more of PLC programming, exchanging data between PLCs, accessing PLC data from one or more SCADA systems, diagnostics, etc. The UDP is a relatively lightweight protocol that operates on top of the Internet protocol (IP). UDP may send packets (units of data) directly to a target device without establishing a connection first. Such an approach may allow for faster data transfer speeds, noting that, in some instances, risks of lost packets, etc., may occur.

In the example of FIG. 7, the system 700 may provide for automation through control logic, assurances of safety via one or more frameworks, and intercept logic (e.g., as in an intercept layer). As shown, the system 700 may provide for data contextualization, data reading for process values, one or more pass-through and/or intercept mechanisms, etc. As indicated, the system 700 may provide an inject mode where, for example, one or more types of commands, data, etc., may be injected from one or more sources (e.g., as new traffic, etc.). As shown, the system 700 may provide for splitting S7 traffic and, for example, sending data via an interception device for dissection, etc.

As an example, one or more of the operator chairs 510, 610, and 710 may include one or more of the features described or shown in the ‘776 application, for example, as referenced with respect to the example chair 312 of FIG. 3.

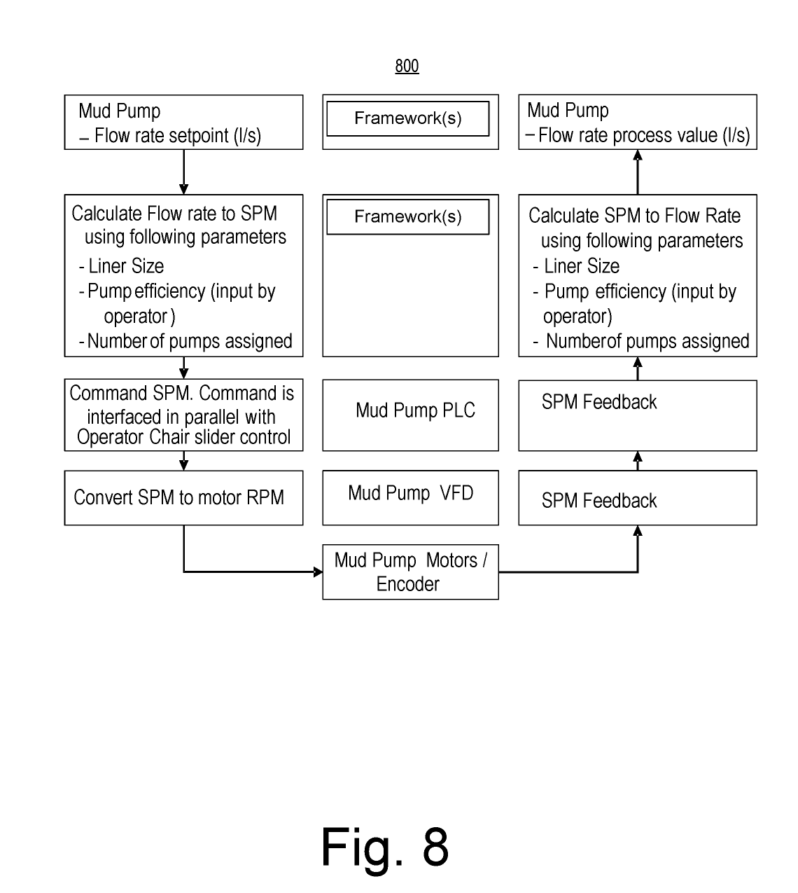

FIG. 8 shows an example of a workflow 800 as associated with a mud pump(s) subsystem. As shown, a framework may generate a flow rate setpoint, which may be in liters or gallons per unit time (e.g., liters per minute, gallons per minute, etc.). In various instances, a mud pump may operate using strokes where strokes per minute (SPM) may be converted to flow rate. In such an example, another framework may utilize one or more parameters such as, for example, liner size, pump efficiency, number of assigned pumps, etc., as may be taken into account to perform such a conversion, noting that one or more of such parameters may vary (e.g., consider efficiency with age, number of assigned pumps with available pumps, etc.). Once an SPM is determined, it may be transmitted to a PLC where, for example, a command SPM may be interfaced in parallel with an operator chair controller (e.g., a slider control, etc.). As shown, output of the PLC may be directed to a VFD where a specified SPM is converted into a motor RPM. As shown, one or more mud pump motors and/or encoders may receive an appropriate signal or signals to effectuate the RPM as corresponding to flow rate to achieve the flow rate setpoint. As shown, feedback may be acquired as to the SPM of the one or more mud pump motors, which may be provided to and/or generated at the VFD and/or the PLC, where such feedback may be received by one or more of the frameworks, which may perform a reverse computation to convert SPM to flow rate, which may be suitable for consumption and assessment by a framework.

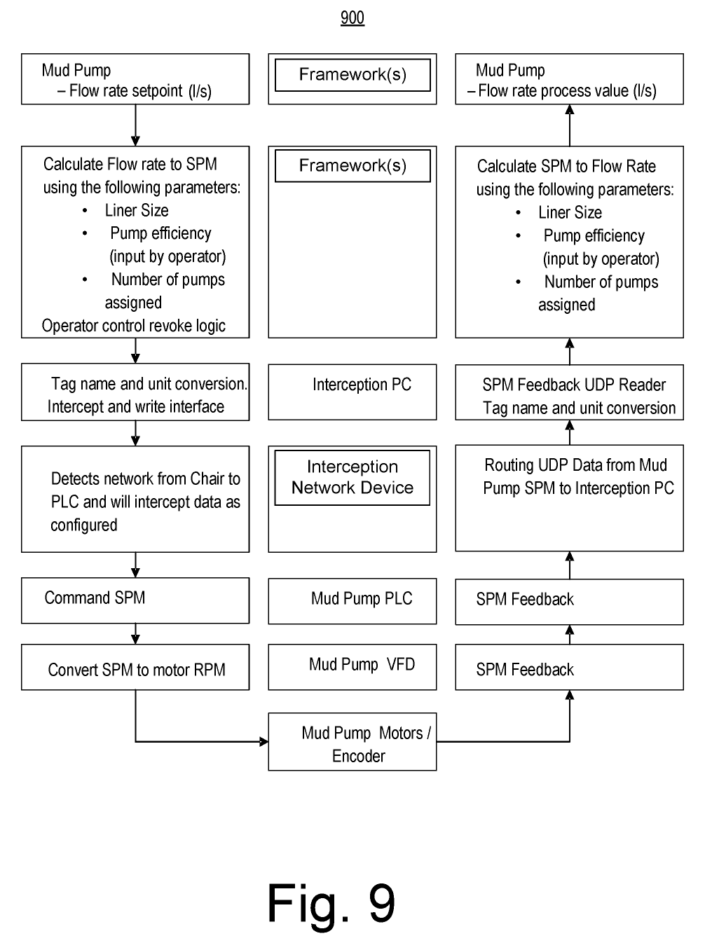

FIG. 9 shows an example of a workflow 900 as associated with a mud pump(s) subsystem. As shown, a framework may generate a flow rate setpoint, which may be in liters or gallons per unit time (e.g., liters per minute, gallons per minute, etc.). In various instances, a mud pump may operate using strokes where strokes per minute (SPM) may be converted to flow rate. In such an example, another framework may utilize one or more parameters such as, for example, liner size, pump efficiency, number of assigned pumps, etc., as may be taken into account to perform such a conversion, noting that one or more of such parameters may vary (e.g., consider efficiency with age, number of assigned pumps with available pumps, etc.).

In contrast to the workflow 800 of FIG. 8, in the example of FIG. 9, an interception layer computing device and an interception layer network device may be implemented. As shown, an interception layer computing device may receive an SPM from a framework and perform one or more tagging operations, which may tag a name and unit conversion, as appropriate. As shown, the computing device may intercept and write an interface such that the network device operates as an interceptor that detects network activity from an operator chair as may be directed to one or more PLCs. In such an example, the network device may intercept data as configured. As an example, the network device may operate at least in part as a firewall.

As an example, a system may operate where existing commands from an operator may still be accepted. As an example, an override mode may be implemented, for example, consider a scenario where an operator command may be detected that may be intended for direct control of one or more pieces of equipment, subsystems, etc. In such an example, in response to detecting and optionally assessing the command, a system may provide for temporarily revoking control provided by a framework. In such an example, a level of automation may be adjusted such that a period of more manual operation is provided (e.g., for a period of time or event trigger as may be appropriate).

In the example of FIG. 9, once an SPM is cleared by the network device, it may be transmitted to a PLC. As shown, output of the PLC may be directed to a VFD where a specified SPM is converted into a motor RPM. As shown, one or more mud pump motors and/or encoders may receive an appropriate signal or signals to effectuate the RPM as corresponding to flow rate to achieve the flow rate setpoint. As shown, feedback may be acquired as to the SPM of the one or more mud pump motors, which may be provided to and/or generated at the VFD and/or the PLC. In such an example, the network device may receive such feedback and provide for appropriate routing of UDP data to the computing device, which may appropriately provide for SPM feedback and UDP reading of tag name, unit conversion, etc. As shown, such feedback may be received by one or more of the frameworks, which may perform a reverse computation to convert SPM to flow rate, which may be suitable for consumption and assessment by a framework. As an example, a method may include adjusting or passing-through a response to an original operator station such that a corresponding GUI is updated.

In the example of FIG. 9, the computing device of the interception layer may provide for data integrity, data enhancement, data storage, etc. For example, high quality data may be generated and stored as to setpoints and implementation thereof. Such data may be appropriately formatted for utilization in one or more machine learning workflows. For example, consider generation of data for training one or more machine learning (ML) models that may be implemented in one or more frameworks for purposes of improving control, monitoring, detection of events, etc. For example, one or more of the frameworks in the workflow 900 may include one or more ML models.

While the example workflows 800 and 900 pertain to mud pumping, a workflow may be implemented for drawworks operations, top drive operations, etc. As an example, a workflow may be implemented for a number of operations, which may include operations using one or more types of subsystems. As an example, a subsystem may be for drilling, cementing, logging, fracturing, sensing, etc.

As an example, a command corpus may provide for a number of commands. For example, consider more than 10 commands, more than 20 commands, more than 30 commands, etc. In such an example, an interception layer may provide for appropriate control and feedback. As explained, an interception layer may provide for contextualizing data, which may include labeling of data. As an example, contextualization may provide for improved understanding of activities, control, feedback, etc. As an example, a system may provide for allowing common supervisory control products that are operable on one or more known interfaces. For example, consider labeling an SPM SP tag as SET_SPM_SP such that a workflow may provide for writing products that utilize SET_SPM_SP for controlling pump SPM.

As an example, an interception layer may provide for one or more interactions via one or more application programming interfaces (APIs). For example, consider interrogation of actions of an interception layer, which may provide for extensibility to enhance contextualization. As an example, an interception layer may provide for generation of data, metadata, contextualization, etc., which may be stored in one or more databases.

As an example, a system may be implemented using one or more networking technologies and/or techniques. As an example, a system may utilize an Ethernet type of network, which may utilize one or more types of protocols. As an example, an Ethernet UDP, as a protocol, may be used for data exchange between S7 types of controllers (e.g., utilizing industrial Ethernet CPs, etc.).

As an example, a system may provide for implementation of one or more levels of automation. For example, consider a system that includes an interface that may provide for interactions for equipment control where such interactions stem from a framework controller, an operator chair, etc.

As an example, a system may be a layered system that may include a network layer, a contextualization layer, and an automation enablement layer. As an example, a system may include computer and network equipment that may be suitable for deployment in a driller’s cabin where one or more operator chairs may be present. As explained, a system may include and/or be operatively coupled to a rig control system (RCS). As an example, a system may be a gateway for rig equipment.

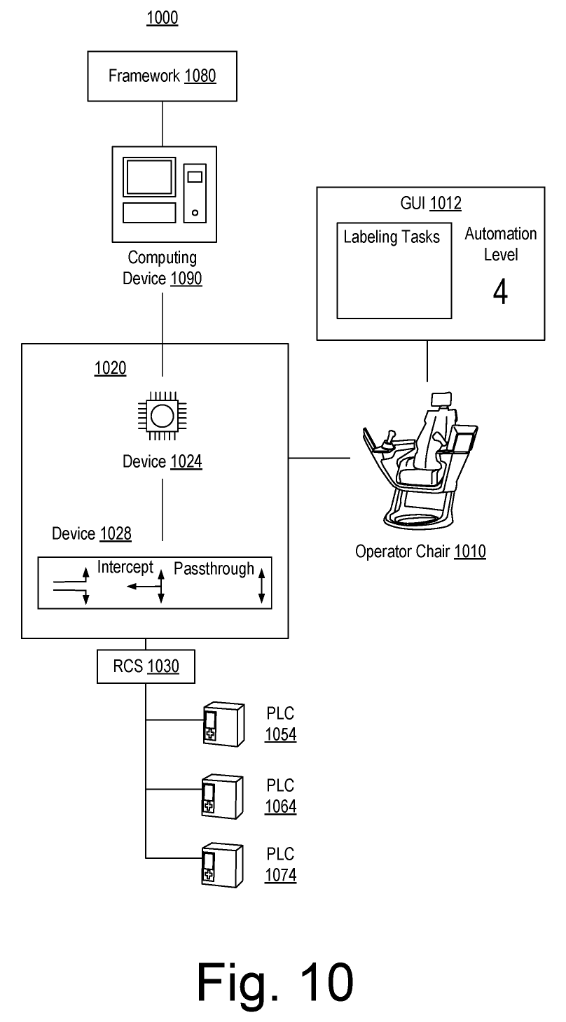

FIG. 10 shows an example of a system 1000 that includes an operator chair 1010, an interception layer 1020 with devices 1024 and 1028, a number of PLCs 1054, 1064, and 1074, along with a framework 1080 and a computing device 1090 that may provide for execution of the framework 1080; noting that a rig control system 1030 may be included in the system 1000. As explained, a system may provide for operation at one or more levels of automation where various levels may include a human-in-the-loop (HITL), which may be a human seated in an operator chair. In the example of FIG. 10, the operator chair 1010 may include one or more displays that can render one or more graphical user interfaces (GUIs) such as, for example, a GUI 1012, which may be rendered to a display along with an indicator as to level of automation, etc. As shown in the example of FIG. 10, the GUI 1012 may provide for labeling such that various scenarios, events, etc., may be labeled by a human. As shown, a number of labeling tasks may be presented to a user such that the user can label data, which may correspond to one or more scenarios, events, etc., which may be normal, abnormal, anomalous, etc. Such labeled data may be utilized for training one or more ML models, which may include one or more ML models that may be utilized within the system 1000. For example, the framework 1080 may utilize one or more trained ML models to effectuate equipment control, planning, execution of the framework, issuance of notifications, etc.

As an example, as a level of automation decreases such that more human attention may be demanded to control one or more subsystems, etc., the type and/or number of labeling tasks may be reduced, which may be reduced to zero where human attention is high. As explained, for various reasons a HITL may be required and where a level of automation is high, a human may have more time to perform one or more tasks other than control and/or monitoring. For example, while a human is sitting in an operator chair, with ample idle time, that human may utilize that otherwise idle time for labeling tasks that add value to a system that can provide for machine learning. As explained, a relationship may exist between level of automation and labeling tasks where, as level of automation decreases, time spent on labeling tasks may increase, and vice versa.

As an example, a system may provide for installation of one or more pieces of equipment, removal of one or more pieces of equipment, etc. (e.g., consider chair installation, chair removal, etc.). As an example, a system may provide for operating as a historian, a quality control assessor, a generator of information for training one or more machine learning models, etc. As an example, a system may provide for recording operations and replaying operations, for example, as one or more operational sequences. As an example, a system may provide for assessing compliance with one or more operating procedures, which may include one or more standard operating procedures (SOPs), etc.

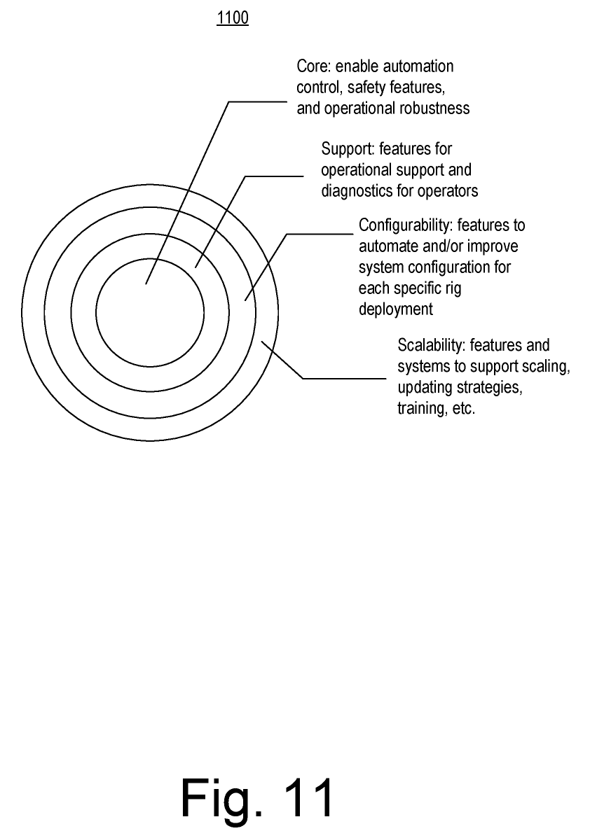

FIG. 11 shows a graphic 1100 of various aspects that a system may possess and/or provide. As shown, the graphic 1100 includes: a core to enable automation control, safety features, and operational robustness; support features for operational support and diagnostics for operators; configurability features to automate and/or improve system configuration for each specific rig deployment; and scalability features and systems to support scaling, updating strategies, training, etc. As an example, a system such as, for example, one or more of the systems 600, 700, 800, 1000, etc., may possess and/or provide one or more of the aspects of the graphic 1100.

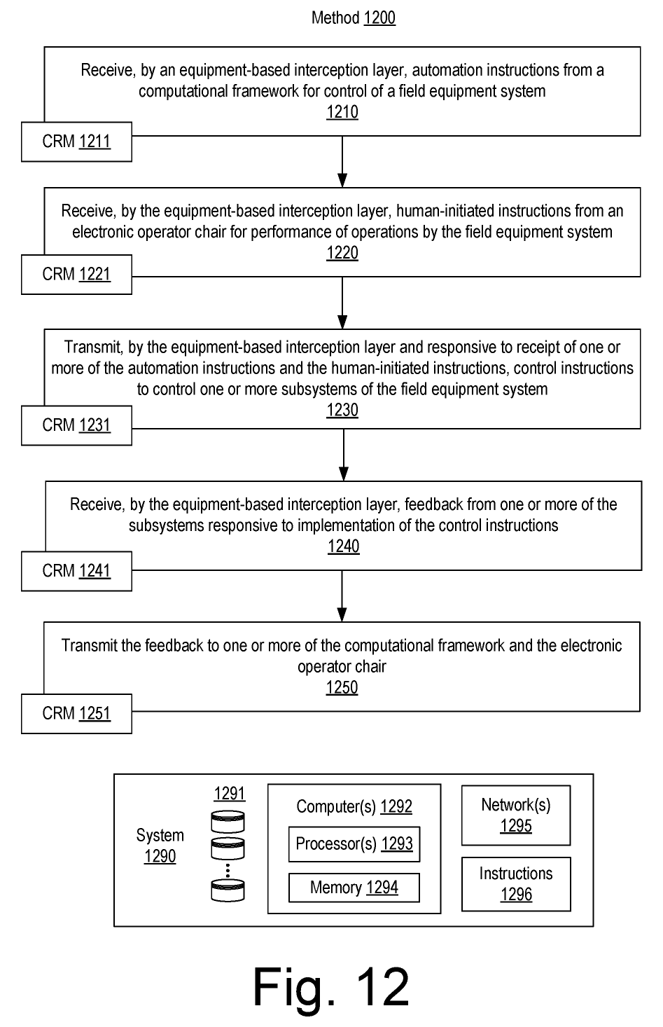

FIG. 12 shows an example of a method 1200 and an example of a system 1290. As shown, the method 1200 may include a reception block 1210 for receiving, by an equipment-based interception layer, automation instructions from a computational framework for control of a field equipment system; a reception block 1220 for receiving, by the equipment-based interception layer, human-initiated instructions from an electronic operator chair for performance of operations by the field equipment system; a transmission block 1230 for transmitting, by the equipment-based interception layer and responsive to receipt of one or more of the automation instructions and the human-initiated instructions, control instructions to control one or more subsystems of the field equipment system; a reception block 1240 for receiving, by the equipment-based interception layer, feedback from one or more of the subsystems responsive to implementation of the control instructions; and a transmission block 1250 for transmitting the feedback to one or more of the computational framework and the electronic operator chair.

FIG. 12 also shows various computer-readable media (CRM) blocks 1211, 1221, 1231, 1241, and 1251. Such blocks may include instructions that are executable by one or more processors, which may be one or more processors of a computational framework, a system, a computer, etc. A computer-readable medium may be a computer-readable storage medium that is not a signal, not a carrier wave and that is non-transitory. For example, a computer-readable medium may be a physical memory component that may store information in a digital format.

In the example of FIG. 12, a system 1290 includes one or more information storage devices 1291, one or more computers 1292, one or more networks 1295 and instructions 1296. As to the one or more computers 1292, each computer may include one or more processors (e.g., or processing cores) 1293 and memory 1294 for storing the instructions 1296, for example, executable by at least one of the one or more processors. As an example, a computer may include one or more network interfaces (e.g., wired or wireless), one or more graphics cards, a display interface (e.g., wired or wireless), etc. The system 1290 may be specially configured to perform one or more portions of the method 1200 of FIG. 12.

As an example, a computational framework may include a solver, which may be implemented via executable instructions. For example, consider a computational framework that includes a processor and memory accessible to the processor where executable instructions may be stored in the memory and accessed for execution by the processor to cause the computational framework to perform one or more actions. Such a computational framework may include one or more interfaces for receipt of information and/or for output of information, which may include values of parameters, an instruction, etc. As an example, a computational framework may be part of a controller. As an example, a computational framework may be part of a system.

As an example, various systems, methods, etc., may implement one or more ML models. As to types of ML models, consider one or more of a support vector machine (SVM) model, a k-nearest neighbors (KNN) model, an ensemble classifier model, a neural network (NN) model, etc. As an example, a machine learning model may be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a system may utilize one or more recurrent neural networks (RNNs). One type of RNN is referred to as long short-term memory (LSTM), which may be a unit or component (e.g., of one or more units) that may be in a layer or layers. A LSTM component may be a type of artificial neural network (ANN) designed to recognize patterns in sequences of data, such as time series data. When provided with time series data, LSTMs take time and sequence into account such that an LSTM may include a temporal dimension. For example, consider utilization of one or more RNNs for processing temporal data from one or more sources, optionally in combination with spatial data. Such an approach may recognize temporal patterns, which may be utilized for making predictions (e.g., as to a pattern or patterns for future times, etc.).

As an example, the TENSORFLOW framework (Google LLC, Mountain View, California) may be implemented, which is an open-source software library for dataflow programming that includes a symbolic math library, which may be implemented for machine learning applications that may include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework (PyTorch Foundation) may be utilized.

As an example, a training method may include various actions that may operate on a dataset to train a ML model. As an example, a dataset may be split into training data and test data where test data may provide for evaluation. A method may include cross-validation of parameters and best parameters, which may be provided for model training.

The TENSORFLOW framework may run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations may be expressed as stateful dataflow graphs; noting that the name TENSORFLOW derives from the operations that such neural networks perform on multidimensional data arrays. Such arrays may be referred to as “tensors”.

As an example, a method may include receiving, by an equipment-based interception layer, automation instructions from a computational framework for control of a field equipment system; receiving, by the equipment-based interception layer, human-initiated instructions from an electronic operator chair for performance of operations by the field equipment system; transmitting, by the equipment-based interception layer and responsive to receipt of one or more of the automation instructions and the human-initiated instructions, control instructions to control one or more subsystems of the field equipment system; receiving, by the equipment-based interception layer, feedback from one or more of the subsystems responsive to implementation of the control instructions; and transmitting the feedback to one or more of the computational framework and the electronic operator chair. In such an example, the field equipment system can be or include a rig system. In such an example, subsystems may be included, which may include, one or more of a drawworks subsystem, a mud pump subsystem, and a top drive subsystem.

As an example, one or more subsystems may include a variable frequency drive (VFD) operatively coupled to at least one motor.

As an example, an equipment-based interception layer may be or include a computing device and a network device. In such an example, the computing device and/or the network device may include one or more processors and associated memory, for example, to store executable instructions. As an example, a network device may include hardware suitable for establishing one or more network interfaces that provide for receipt and/or transmission of network messages, which may comport with one or more protocols.

As an example, a computing device may contextualize at least automation instructions. As an example, a network device may include features for implementation of a UDP. In such an example, the network device may include features for implementation of an S7 protocol.

As an example, an equipment-based interception layer may include features for implementation of multiple, different network protocols. In such an example, the multiple, different network protocols may include a first protocol for network communications with an operator chair and a second protocol for network communications with one or more subsystems.

As an example, a method may include generating a database based at least in part on automation instructions and human-initiated instructions. In such an example, generating may be based at least in part on feedback.

As an example, a method may include training a machine learning model using a database. As an example, one or more pieces of equipment may provide for accessing a trained machine learning model. In such an example, consider providing input to the trained machine learning model and receiving output in response. In such an example, the output may be germane to control of one or more pieces of equipment, which may be part of one or more subsystems. As an example, a trained machine learning model may provide for making decisions as to transmissions of notifications, control commands, etc. For example, consider one or more interception layer components being controlled via machine learning model decision-making, which may occur automatically, for example, responsive to input, determinations as to context, etc.

As an example, a method may include generating a database based at least in part on labels assigned via human interactions with an operator chair. For example, consider human interactions with an instrumented operator chair, which may include one or more associated displays. In such an example, a display may be a monitor for rendering graphics, images, video, etc. As an example, a display may provide for rendering real-time, live images of one or more pieces of equipment, optionally with one or more overlays. As an example, an operator chair may include one or more types of human-machine interfaces (HMIs), which may provide for receiving input from a human.

As an example, a method may include rendering a graphical user interface to a display of an operator chair based at least in part on feedback. In such an example, the method may include receiving a label assigned to at least a portion of the feedback by human interaction with the operator chair (e.g., via one or more HMIs, etc.).

As an example, a method may include adjusting a level of automation for control of one or more subsystems. In such an example, adjusting may be based at least in part on feedback. As to levels of automation, as an example, a system may operate subsystems at an overall level of automation and/or at individual levels of automation, which may differ for each of the subsystems. As explained, in various instances, a goal may be to operate at a safe level of automation where one or more operational tasks may be performed automatically by machine without human interaction though with human oversight. In such an approach, where safety may be at risk, a lower level of automation may be implemented such that human interaction occurs, for example, to manually control one or more pieces of equipment while some amount of automation may still occur. As an example, various subsystems may be operable along a spectrum of manual to automatic operation. As to manual operation, such an approach may involve actuating a control, a button, turning a valve, a knob, etc., pulling a lever, etc.

As an example, manual operation may be achieved for various operations while an operator is seated in an operator chair, while various other types of manual operation may demand that a human be present at a piece of equipment in the field to manually operate that piece of equipment. In various instances, manual operation may demand more than one human such that one human remains seated in an operator chair while another human is mobile for addressing one or more manual tasks at one or more pieces of equipment.

As an example, a system may include one or more processors; memory accessible to at least one of the one or more processors; and processor-executable instructions stored in the memory and executable to instruct the system to: receive automation instructions from a computational framework for control of a field equipment system; receive human-initiated instructions from an electronic operator chair for performance of operations by the field equipment system; transmit, responsive to receipt of one or more of the automation instructions and the human-initiated instructions, control instructions to control one or more subsystems of the field equipment system; receive feedback from one or more of the subsystems responsive to implementation of the control instructions; and transmit the feedback to one or more of the computational framework and the electronic operator chair.

As an example, one or more computer-readable storage media may include processor-executable instructions to instruct a computing system to: receive automation instructions from a computational framework for control of a field equipment system; receive human-initiated instructions from an electronic operator chair for performance of operations by the field equipment system; transmit, responsive to receipt of one or more of the automation instructions and the human-initiated instructions, control instructions to control one or more subsystems of the field equipment system; receive feedback from one or more of the subsystems responsive to implementation of the control instructions; and transmit the feedback to one or more of the computational framework and the electronic operator chair.

As an example, a computer program product that may include computer-executable instructions to instruct a computing system to perform one or more methods such as one or more of the methods described herein (e.g., in part, in whole and/or in various combinations).

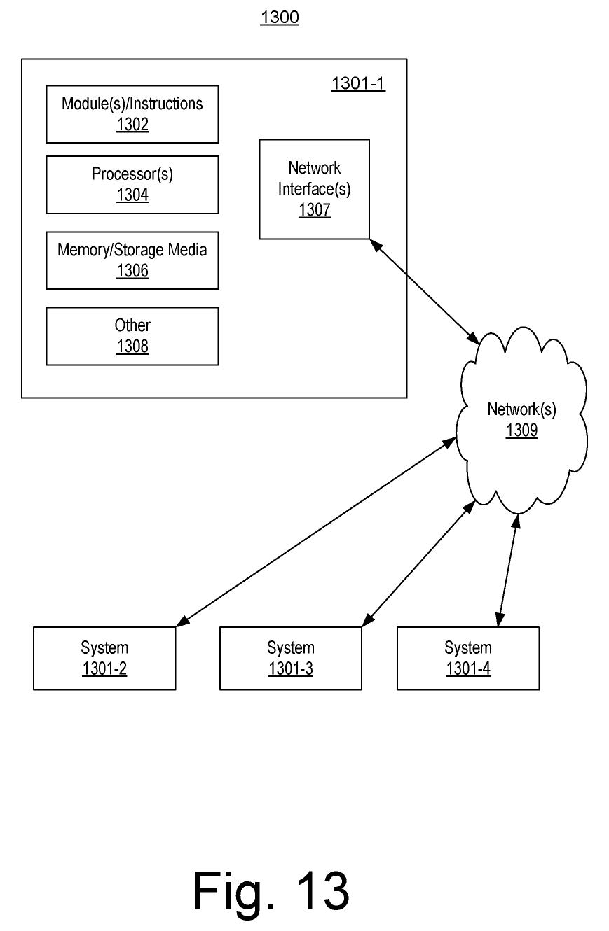

In some embodiments, a method or methods may be executed by a computing system. FIG. 13 shows an example of a system 1300 that may include one or more computing systems 1301-1, 1301-2, 1301-3 and 1301-4, which may be operatively coupled via one or more networks 1309, which may include wired and/or wireless networks. As shown, the system 1300 may include one or more other components 1308.

As an example, a system may include an individual computer system or an arrangement of distributed computer systems. In the example of FIG. 13, the computer system 1301-1 may include one or more modules 1302, which may be or include processor-executable instructions, for example, executable to perform various tasks (e.g., receiving information, requesting information, processing information, simulation, outputting information, etc.).

As an example, a module may be executed independently, or in coordination with, one or more processors 1304, which is (or are) operatively coupled to one or more storage media 1306 (e.g., via wire, wirelessly, etc.). As an example, one or more of the one or more processors 1304 may be operatively coupled to at least one of one or more network interface 1307. In such an example, the computer system 1301-1 may transmit and/or receive information, for example, via the one or more networks 1309 (e.g., consider one or more of the Internet, a private network, a cellular network, a satellite network, etc.). As shown, one or more other components 1308 may be included in the computer system 1301-1.

As an example, the computer system 1301-1 may receive from and/or transmit information to one or more other devices, which may be or include, for example, one or more of the computer systems 1301-2, etc. A device may be located in a physical location that differs from that of the computer system 1301-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1306 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that may be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving, by an equipment-based interception layer, automation instructions from a computational framework for control of a field equipment system;
receiving, by the equipment-based interception layer, human-initiated instructions from an electronic operator chair for performance of operations by the field equipment system;
transmitting, by the equipment-based interception layer and responsive to receipt of one or more of the automation instructions and the human-initiated instructions, control instructions to control one or more subsystems of the field equipment system;
receiving, by the equipment-based interception layer, feedback from one or more of the subsystems responsive to implementation of the control instructions; and
transmitting the feedback to one or more of the computational framework and the electronic operator chair.

2. The method of claim 1, wherein the field equipment system comprises a rig system.

3. The method of claim 1, wherein the subsystems comprises one or more of a drawworks subsystem, a mud pump subsystem, and a top drive subsystem.

4. The method of claim 1, wherein one or more of the subsystems comprises a variable frequency drive operatively coupled to at least one motor.

5. The method of claim 1, wherein the equipment-based interception layer comprises a computing device and a network device.

6. The method of claim 5, wherein the computing device contextualizes at least the automation instructions.

7. The method of claim 5, wherein the network device comprises features for implementation of a user datagram protocol.

8. The method of claim 7, wherein the network device comprises features for implementation of an S7 protocol.

9. The method of claim 1, wherein the equipment-based interception layer comprises features for implementation of multiple, different network protocols.

10. The method of claim 9, wherein the multiple, different network protocols comprise a first protocol for network communications with the operator chair and a second protocol for network communications with the subsystems.

11. The method of claim 1, comprising generating a database based at least in part on the automation instructions and the human-initiated instructions.

12. The method of claim 11, wherein the generating is based at least in part on the feedback.

13. The method of claim 11, comprising training a machine learning model using the database.

14. The method of claim 11, wherein the generating is based at least in part on labels assigned via human interactions with the operator chair.

15. The method of claim 1, comprising rendering a graphical user interface to a display of the operator chair based at least in part on the feedback.

16. The method of claim 15, comprising receiving a label assigned to at least a portion of the feedback by human interaction with the operator chair.

17. The method of claim 1, comprising adjusting a level of automation for control of one or more of the subsystems.

18. The method of claim 17, wherein the adjusting is based at least in part on the feedback.

19. A system comprising:
one or more processors;
memory accessible to at least one of the one or more processors; and
processor-executable instructions stored in the memory and executable to instruct the system to:
receive automation instructions from a computational framework for control of a field equipment system;
receive human-initiated instructions from an electronic operator chair for performance of operations by the field equipment system;
transmit, responsive to receipt of one or more of the automation instructions and the human-initiated instructions, control instructions to control one or more subsystems of the field equipment system;
receive feedback from one or more of the subsystems responsive to implementation of the control instructions; and
transmit the feedback to one or more of the computational framework and the electronic operator chair.

20. One or more computer-readable storage media comprising processor-executable instructions to instruct a computing system to:
receive automation instructions from a computational framework for control of a field equipment system;
receive human-initiated instructions from an electronic operator chair for performance of operations by the field equipment system;
transmit, responsive to receipt of one or more of the automation instructions and the human-initiated instructions, control instructions to control one or more subsystems of the field equipment system;
receive feedback from one or more of the subsystems responsive to implementation of the control instructions; and
transmit the feedback to one or more of the computational framework and the electronic operator chair.
